(19) United States
(12) Patent Application Publication
(10) Pub. No.: US 2013/0057564 A1
(43) Pub. Date: Mar. 7, 2013

(54) IMAGE PROCESSING APPARATUS, IMAGE PROCESSING METHOD, AND IMAGE PROCESSING PROGRAM

(71) Applicant: Mamoru Kamiya, Kanagawa (JP)

(72) Inventor: Mamoru Kamiya, Kanagawa (JP)

(73) Assignee: Renesas Electronics Corporation

(21) Appl. No.: 13/588,751

(22) Filed: Aug. 17, 2012

(30) Foreign Application Priority Data
Sep. 1, 2011 (JP) 2011-190523

(51) Int. Cl. G09G 5/36

(52) U.S. Cl. 345/545

(57) ABSTRACT

A system control unit 110 supplies frame data in a raster scan form. The system control unit 110 also supplies a data enable signal indicating effectiveness/ineffectiveness of each pixel data in the frame data at the same time. A line buffer 120 successively holds pixel data contained in the frame data. An effective data detection unit 130 detects an effective data section of the frame data based on the data enable signal. A comparison unit 140 compares the effective data section detected by the effective data detection unit 130 with a pre-specified display size. A pixel data acquisition unit 150 acquires pixel data from the line buffer 120 based on a comparison result obtained by the comparison unit 140.

### CROSS-REFERENCE TO RELATED APPLICATIONS

This application is based upon and claims the benefit of priority from Japanese patent application No. 2011-190523, filed on Sep. 1, 2011, the disclosure of which is incorporated herein in its entirety by reference.

### BACKGROUND

The present invention related to an image processing apparatus, an image processing method, and an image processing program.

In recent years, image display apparatuses using a liquid crystal panel (preferably, an LCD (Liquid Crystal Display) panel) have been widely used. (The following explanation is made by using an LCD as an example.) These image display apparatuses can display high-resolution images by their LCD panel. These image display apparatuses (such as a liquid crystal television set) are equipped with, for each product, an image processing unit and an LCD module equipped with an LCD panel. Data communication between the image processing unit and the LCD module has been performed in accordance with a specific protocol. A lot of image display apparatuses includes a semiconductor integrated circuit that improves the image quality of image data output from the image processing unit (hereinafter referred to as “image improving chip”) between the image processing unit and the LCD module. By improving images by using this image improving chip, the higher image quality is achieved and higher values are thereby added to products.

However, the protocol that is used for data communication between the image processing unit and the LCD module is often different from one product model to another. That is, the protocol is different depending on the product model. Therefore, when an image improving chip is to be developed, it is necessary to design an image improving chip in accordance with each protocol. In particular, it is necessary to design a process for extracting image data from frame data for each protocol, and thus causing a problem that the development cost increases and so on. Accordingly, it has been desired to develop a technique for accurately extracting image data from frame data independently of the protocol.

As an example, Japanese Unexamined Patent Application Publication No. 2009-164812 (hereinafter referred to as “Patent literature 1”) discloses a technique for extracting image data from frame data. A video data receiving apparatus disclosed in Patent literature 1 is explained hereinafter.

FIG. 16 is a block diagram showing a configuration of a video data transmitting/receiving system including that video data receiving apparatus (receiver module). The video data transmitting/receiving system 300 includes a video data transmitter module 310 (hereinafter referred to as “transmitter module 310”) and a video data receiver module 320 (hereinafter referred to as “receiver module 320”). The transmitter module 310 supplies an interface signal to the receiver module 320. The interface signal is composed of a clock signal, a video data signal, a horizontal synchronization signal, a vertical synchronization signal, and a field index signal. Note that these signals may be transmitted in a superposed state.

FIG. 17 shows a typical protocol for the interface signal. The transmitter module 310 supplies a video data signal to the receiver module 320 The video data signal is generated by performing a raster scan on each of the pixels forming the video data of each frame shown in FIG. 17 (field in this example) from the upper-left corner in the horizontal direction in synchronization with the clock signal. The raster scan is a type of scan method in which: the scanning is started from the left end of the top line and moved to the right one by one; when the scanning reaches the right end of the top line, then the scanning is moved from the left end of the second line to the right end of the second line; and the scanning is moved one line after another in a similar manner until the bottom line is scanned.

A vertical synchronization signal (VSYNC) is asserted at the head of each field and a horizontal synchronization signal (HSYNC) is asserted at the head of each line. The cycles of these synchronization signals are determined based on the video format. Therefore, as long as normal signals are transmitted, the receiver module 320 can specify the video format by detecting the horizontal synchronization signal and the vertical synchronization signal.

As shown in FIG. 17, each field of each video data is composed of an area that is an image to be actually displayed (image area) and an area other than this image area. The determination of this image area is made by using an ENABLE IN signal.

FIG. 18 is a block diagram showing a configuration of the receiver module 320 disclosed in Patent literature 1. The receiver module 320 includes a synchronization detection block 321, an effective data area information detection block 322, an effective data determination block 323, and an effective data extraction block 324.

A clock signal, a horizontal synchronization signal, a vertical synchronization signal, a field index signal, and a video data signal are input to the synchronization detection block 321. Note that the horizontal synchronization signal, the vertical synchronization signal, and the field index signal may be also called “synchronization signal”. The synchronization detection block 321 detects information about the horizontality, the verticality, and the field from the respective synchronization signals that are input in synchronization with the video data (or from synchronization information superposed onto the video data signal). Then, the synchronization detection block 321 calculates pixel position information, which is information of the currently-processed field and (coordinate) position information within that field, based on the detected information. The synchronization detection block 321 supplies the detected pixel position information to the effective data area information detection block 322 and the effective data determination block 323.

A video data signal is also input to the effective data area information detection block 322. Note that the clock signal is supplied to every block shown in FIG. 18.

FIG. 19 shows an example of field data that is to be processed by the receiver module 320. As shown in the figure, this field data 400 is composed of effective data area information 410, an effective data area 420, and a blanking area 430. The effective data area 420 is an area to be displayed, i.e., an area indicating video data. The effective data area information 410 is disposed inside the blanking area 430 and is information indicating specifications and the like of this video data. The effective data area information 410 is information containing, for example, the start point P1 and the endpoint P2 of the effective data area 420 in FIG. 19. As shown in figure, the effective data area information 410 is disposed (coordinates are defined) in such a manner that the effective data area information 410 is read temporally earlier than the effective data area 420.

Here, FIG. 18 is referred to again. The effective data area information detection block 322 detects effective data area information 410 and supplies the detected effective data area information 410 to the effective data determination block 323. Note that the effective data area information detection block 322 has advance information about the timing (coordinates) at which the effective data area information 410 is input.

Pixel position information of a pixel to be processed and effective data area information are input to the effective data determination block 323. The effective data determination block 323 determines whether or not the pixel to be processed is a pixel located within the effective data area information 410, and supplies the determination result to the effective data extraction block 324 as effective data flag information.

The effective data extraction block 324 extracts the pixel data only when the effective data flag information indicates that the pixel is a pixel located within the effective data area information 410. The effective data extraction block 324 supplies the extracted pixel data to an arbitrary image processing module and/or a storage device such as a memory. This pixel data is used for display in a display device (not shown). Note that in FIG. 18, the flow of video data is indicated by bold dotted lines.

With the above-described configuration, the receiver module 320 can acquire effective video data in real time.

### SUMMARY

The present inventors have found the following problem. The effective data area information detection block 322 disclosed in Patent literature 1 operates on the precondition that the effective data area information detection block 322 has advance information about the timing at which the effective data area information 410 is input. However, as described previously, data that is transmitted from the transmitter module 310 to the receiver module 320 is transferred in accordance with various protocols. Therefore, in reality, it is very difficult for the effective data area information detection block 322 to have the advance information about the timing at which the effective data area information 410 is input. That is, the technique disclosed in Patent literature 1 uses a configuration that is very difficult to be applied in actual situations.

Next, extraction of image data using an ENABLE IN signal is examined hereinafter. The above-mentioned ENABLE IN signal has an effective value (1) for pixels corresponding to the effective data area information 410 and the effective data area 420. Therefore, when image data is to be extracted by referring to the value of the ENABLE_IN signal, pixels of the effective data area information 410 and the like, which are not image data, are also determined to be image data.

When the effective data area information 410, which is not image data, is acquired as an image, the display unit (not shown) cannot perform the image display operation appropriately. Further, there is a possibility that an area that is larger than the actual image area is detected as an image area.

That is, in the above-described technique, there is a possibility that when a certain kind of pixel data is extracted from frame data, the type of the pixel data is incorrectly extracted.

A first aspect of the present invention is

an image processing apparatus that processes frame data in a raster scan form, the frame data being input in synchronization with a data enable signal indicating effectiveness/ineffectiveness of each pixel data, the image processing apparatus including:

a buffer unit that successively holds pixel data contained in the frame data;

an effective data detection unit that detects an effective data section of the frame data based on the data enable signal;

a comparison unit that compares the effective data section detected by the effective data detection unit with a pre-specified display size; and

a pixel data acquisition unit that acquires pixel data from the buffer unit based on a comparison result obtained by the comparison unit.

Another aspect of the present invention is

an image processing method for processing frame data in a raster scan form, the frame data being input in synchronization with a data enable signal indicating effectiveness/ineffectiveness of each pixel data, the image processing method including:

detecting an effective data section of the frame data based on the data enable signal;

comparing the detected effective data section with a pre-specified display size; and

acquiring pixel data contained in the frame data based on a comparison result.

Another aspect of the present invention is

an image processing program that causes a computer to execute the above-described image processing method.

According to an aspect of the present invention, it is possible to determine whether pixel data contained in an effective data section is suited for display or not by detecting an effective data section and comparing this effective data section with a display size. As a result, it is possible to acquire pixel data with accuracy without incorrectly extracting the type of the pixel data.

According to an aspect of the present invention, it is possible to provide an image processing apparatus, an image processing method, and an image processing program, capable of, when a certain kind of pixel data is to be extracted from frame data, acquiring the pixel data with accuracy.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of an image processing apparatus according to a first embodiment of the present invention;

FIG. 2 is a flowchart showing a one-line process performed by an image processing apparatus according to a first embodiment of the present invention;

FIG. 3 is a flowchart showing a one-line process performed by an image processing apparatus according to a first embodiment of the present invention;

FIG. 4 is a timing chart showing a process performed by an image processing apparatus according to a first embodiment of the present invention;

FIG. 5 is a block diagram showing a configuration of an image processing apparatus according to a second embodiment of the present invention;

FIG. 6 is a flowchart showing a one-line process performed by an image processing apparatus according to a second embodiment of the present invention;

FIG. 7 is a flowchart showing a one-line process performed by an image processing apparatus according to a second embodiment of the present invention;

FIG. 8 is a timing chart showing a process performed by an image processing apparatus according to a second embodiment of the present invention;

FIG. 9 is a block diagram showing a configuration of an image processing apparatus according to a third embodiment of the present invention;

FIG. 10 is a flowchart showing a one-line process performed by an image processing apparatus according to a third embodiment of the present invention;

FIG. 11 is a timing chart showing a process performed by an image processing apparatus according to a third embodiment of the present invention;

FIG. 12 is a block diagram showing a configuration of an image processing apparatus according to a fourth embodiment of the present invention;

FIG. 13 is a timing chart showing a process performed by an image processing apparatus according to a fourth embodiment of the present invention;

FIG. 14 is a block diagram showing a configuration of an image processing apparatus according to another embodiment of the present invention;

FIG. 15 is a block diagram showing a hardware configuration example of a computer system for implementing an image processing apparatus according to an aspect of the present invention;

FIG. 16 is a block diagram showing a configuration of an video data transmitting/receiving system disclosed in Patent literature 1;

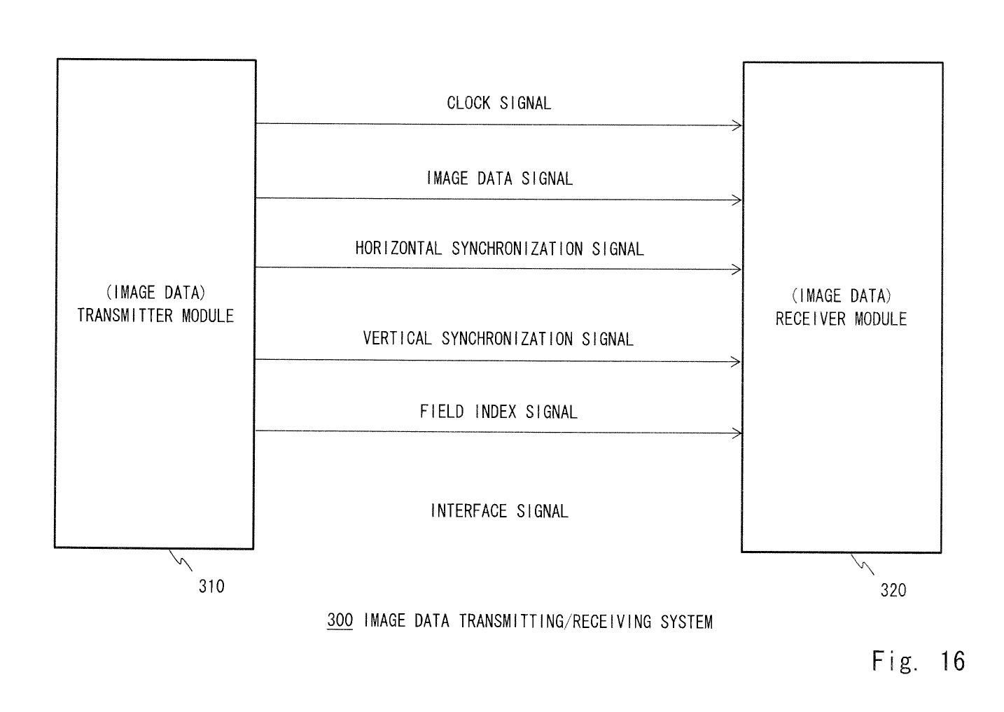

FIG. 17 is a conceptual diagram showing a typical protocol of an interface signal;

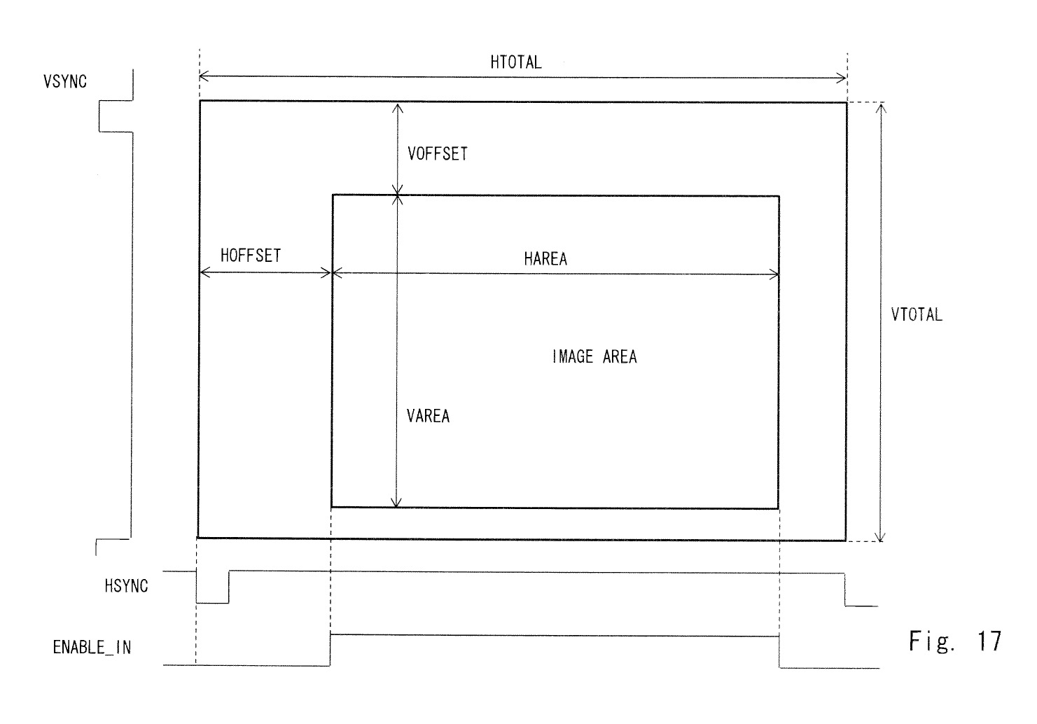

FIG. 18 is a block diagram showing a configuration of a receiver module disclosed in Patent literature 1; and

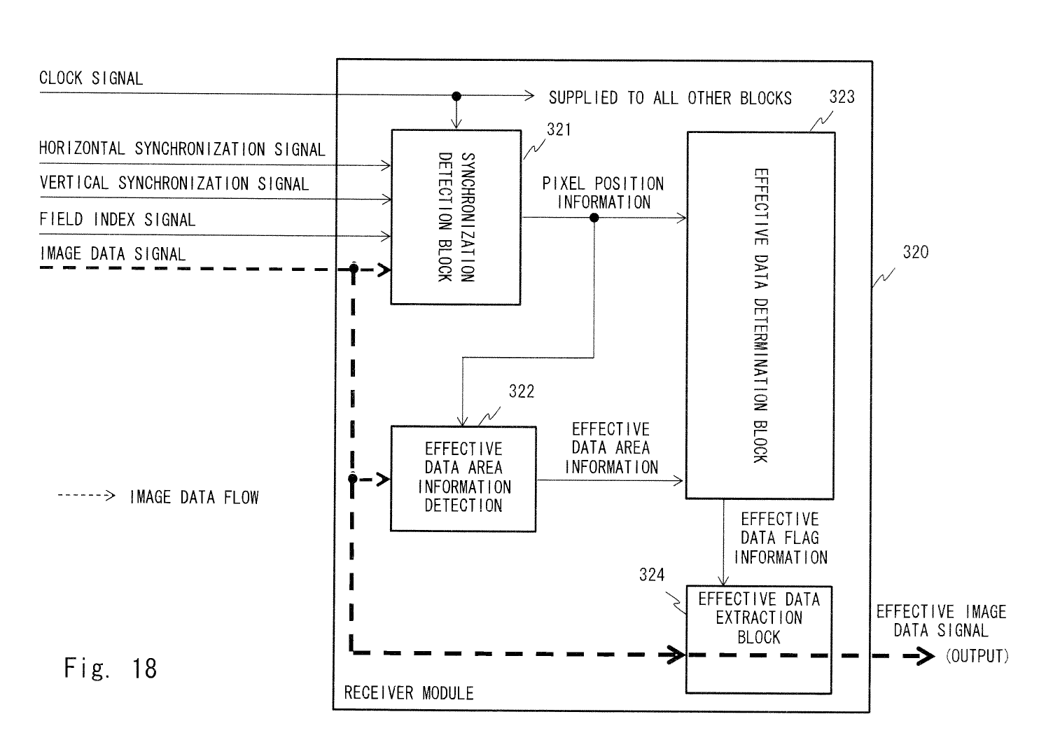

FIG. 19 is a conceptual diagram showing an example of frame date.

### DETAILED DESCRIPTION

Embodiments according to the present invention are explained hereinafter with reference to the drawings. For clarifying the explanation, some parts of the following descriptions and the drawings may be omitted or simplified as appropriate. Note that the same symbols are assigned to the same components throughout the drawings, and their duplicated explanation is omitted as appropriate.

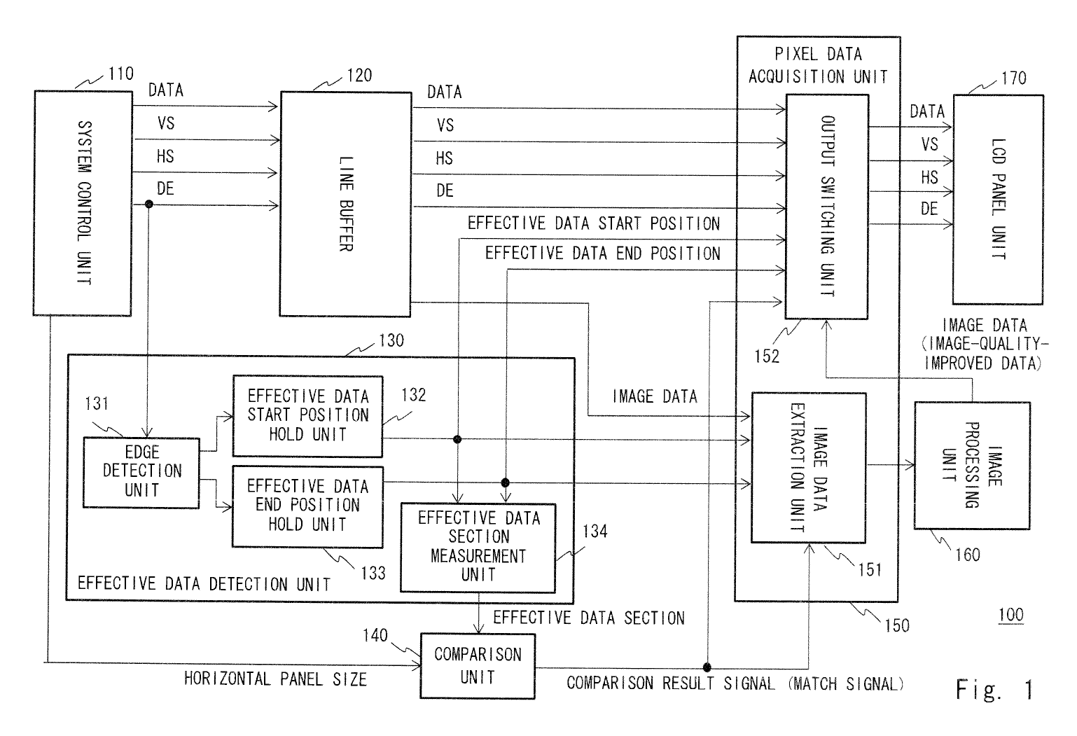

FIG. 1 is a block diagram showing a configuration of an image processing apparatus 100 according to this embodiment of the present invention. The image processing apparatus 100 includes a system control unit 110, a line buffer 120, an effective data detection unit 130, a comparison unit 140, a pixel data acquisition unit 150, an image processing unit 160, and an LCD panel unit 170.

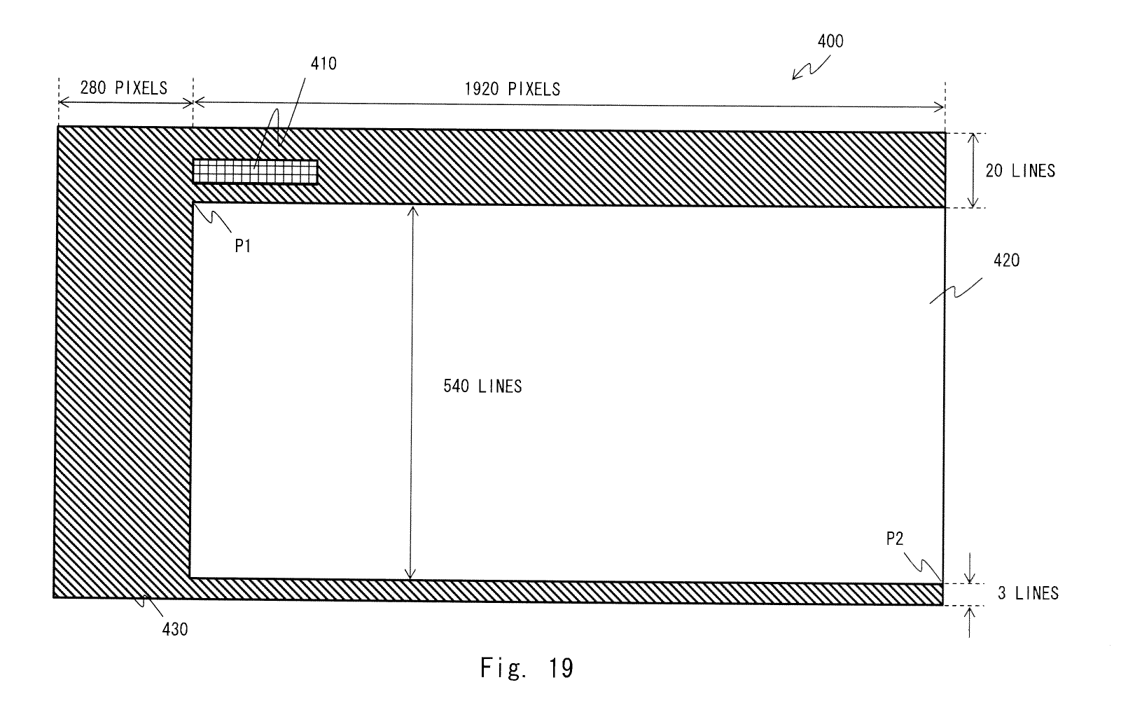

The system control unit 110 is a processing unit that generates frame data containing an image area and supplies the generated frame data to a subsequent processing unit together with synchronization signals (VS and HS) and a data enable signal. Note that the frame data may be generated by other processing units, and the system control unit 110 may acquire that frame data from the other processing units. The frame data generated by the system control unit 110 is, for example, data in the format shown in FIG. 19. That is, the frame data has such a structure that image data and data other than image data (e.g., code data such as effective data area information 410 shown in FIG. 19) can be contained as effective data (pixel data having coordinates for which the DE (Data Enable) signal becomes 1).

The system control unit 110 reads out frame data by using a raster scan method and writes the read pixel data into the line buffer 120. In addition to this pixel data writing operation, the system control unit 110 also writes a VS (Vertical Synchronization) signal, a HS (Horizontal Synchronization) signal, and a DE (Data Enable) signal into the line buffer 120. At the same time, the system control unit 110 supplies the DE signal to an edge detection unit 131 located in the effective data detection unit 130.

Further, the system control unit 110 also performs the overall control of the system and holds information about the horizontal panel size of the LCD panel unit 170 (which is explained later). The system control unit 110 supplies the information about the horizontal panel size to the comparison unit 140.

The line buffer 120 is a storage unit that successively holds pixel data of the frame data supplied from the system control unit 110 and values of the above-mentioned signals (VS signal, HS signal, and DE signal).

The effective data detection unit 130 includes an edge detection unit 131, an effective data start position hold unit 132, an effective data end position hold unit 133, and an effective data section measurement unit 134. The effective data detection unit 130 is a processing unit that detects a section in which effective data of the frame data is transferred (hereinafter also referred to as “effective data section”) based on the DE signal. Each processing unit located within the effective data detection unit 130 is explained hereinafter in detail.

A DE signal is supplied to the edge detection unit 131. The edge detection unit 131 detects an edge (rising edge or falling edge) of the DE signal. When a rising edge is detected, the edge detection unit 131 supplies a detection signal to the effective data start position hold unit 132. When a falling edge is detected, the edge detection unit 131 supplies a detection signal to the effective data end position hold unit 133.

The effective data start position hold unit 132 holds the coordinate position of a pixel that is being processed when the detection signal is input (coordinate position when the edge is detected) and supplies that coordinate position to the effective data section measurement unit 134, an image data extraction unit 151, and an output switching unit 152. Note that this coordinate position is also referred to as “effective data start position” in the following explanation.

The effective data end position hold unit 133 holds the coordinate position of a pixel that is being processed when a detection signal is input (coordinate position when the edge is detected) and supplies that coordinate position to the effective data section measurement unit 134, the image data extraction unit 151, and the output switching unit 152. Note that this coordinate position is also referred to as “effective data end position” in the following explanation.

Note that each of the effective data start position hold unit 132 and the effective data end position hold unit 133 may also hold information about the time at which the detection signal is input. The DE signal is supplied in synchronization with the clock signal. Similarly, the frame data is read out in synchronization with the clock signal by raster scanning and written into the line buffer 120 Therefore, if necessary, the time information can be converted from/into the coordinate position information.

The effective data section measurement unit 134 is a processing unit that measures an effective data section. For example, when X1 and X2 are input as the x-coordinate of an effective data start position and the x-coordinate of an effective data end position respectively, the effective data section measurement unit 134 acquires the section between X1 and X2 as an effective data section. The effective data section measurement unit 134 supplies the acquired effective data section to the comparison unit 140.

The comparison unit 140 is a processing unit that determines whether or not the input effective data section conforms to the horizontal panel size. That is, the comparison unit 140 determines whether the input effective data section is image data or not. When the effective data section conforms to the horizontal panel size (i.e., when the effective data section is image data), the comparison unit 140 supplies a match signal to the image data extraction unit 151 and the output switching unit 152 as a comparison result signal.

Note that the comparison unit 140 may output the (match) signal only when the effective data section conforms to the horizontal panel size. Alternatively, the comparison unit 140 may continuously supply the comparison result signal. In this case, when “1” is output as the comparison result signal, it may indicate “matching”, whereas when “0” is output as the comparison result signal, it may indicate “non-matching”. In the following explanation, the comparison unit 140 continuously supplies the comparison result signal.

The pixel data acquisition unit 150 includes an image data extraction unit 151 and an output switching unit 152.

The effective data start position, the effective data end position, and the comparison result signal are input to the image data extraction unit 151. When the comparison result signal is a signal indicating matching, the image data extraction unit 151 determines that the pixel data contained between the effective data start position and the effective data end position is image data and acquires this pixel data from the line buffer 120. In the following explanation, the section in which image data is contained is also referred to as “image data transfer section”. The image data extraction unit 151 supplies the acquired image data to the image processing unit 160.

The image processing unit 160 performs processing such as image improving processing for the image data extracted by the image data extraction unit 151 and supplies the processed image data to the output switching unit 152.

The effective data start position, the effective data end position, and the comparison result signal are input to the output switching unit 152. When a match signal is input as the comparison result signal, the output switching unit 152 holds the effective data start position and the effective data end position that were input simultaneously with the match signal. That is, the output switching unit 152 memorizes the image data transfer section.

The output switching unit 152 supplies the pixel data to the LCD panel unit 170 after the one-line process performed by the effective data detection unit 130 and the comparison unit 140 has finished. In particular, in the image data transfer section, the output switching unit 152 supplies the pixel data acquired from the image processing unit 160. Note that in addition to supplying the pixel data, the output switching unit 152 reads out a VS signal, an HS signal, and a DE signal corresponding to that pixel data from the line buffer 120 and supplies the read signals to the LCD panel unit 170.

On the other hand, in the section(s) other than the image data transfer section, the output switching unit 152 supplies the pixel data read out from the line buffer 120 to the LCD panel unit 170 without performing any processing for the pixel data. Further, in addition to supplying the pixel data, the output switching unit 152 supplies a VS signal, an HS signal, and a DE signal corresponding to that pixel data to the LCD panel unit 170.

The LCD panel unit 170 includes a typical liquid crystal panel and a control unit for the liquid crystal panel, and displays image data on a display screen according to supplied pixel data, a VS signal, an HS signal, and a DE signal.

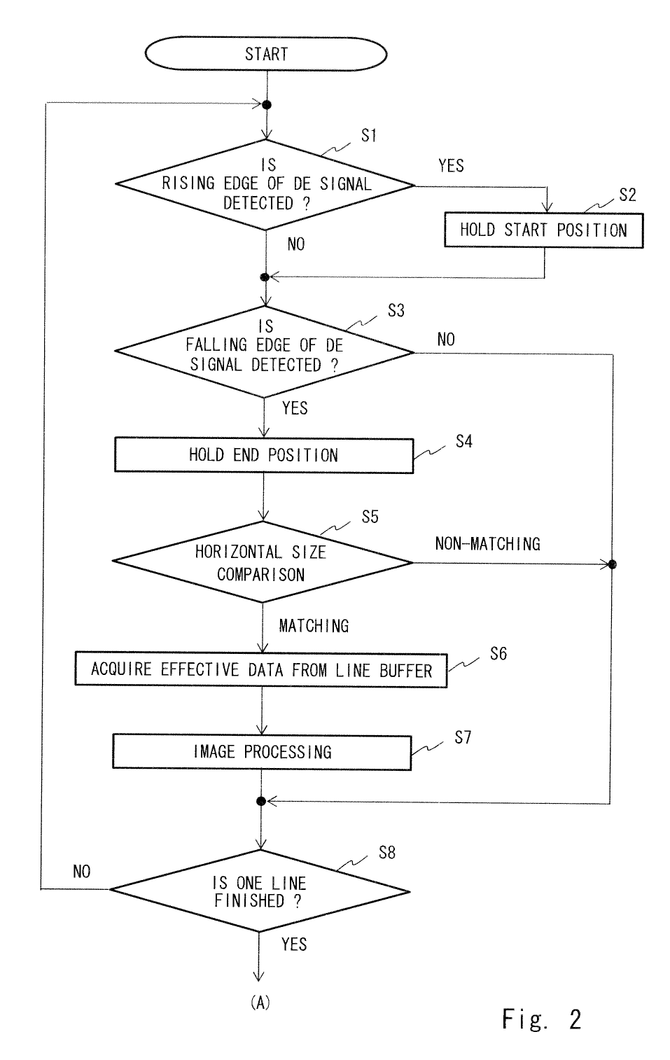

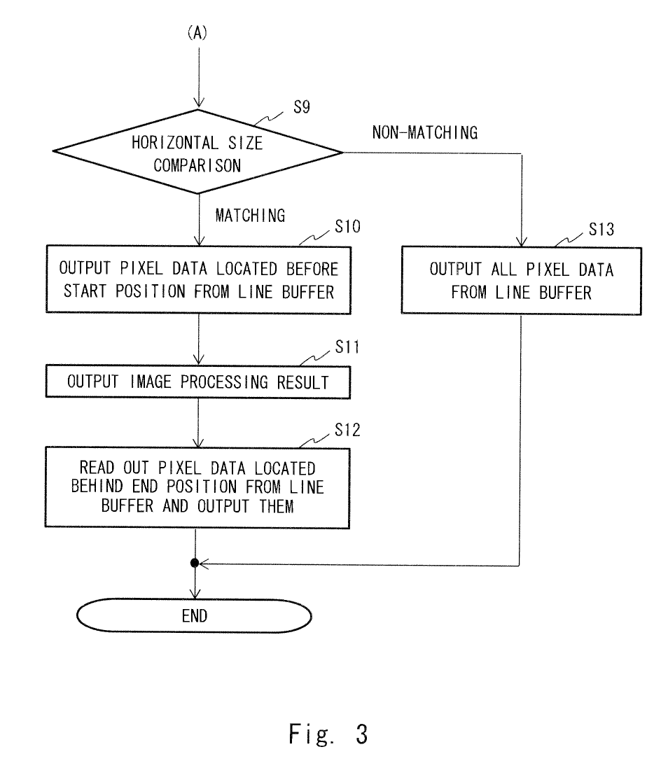

Next, a flow of a horizontal one-line process performed by the image processing apparatus 100 according to this embodiment is explained with reference to FIGS. 2 and 3. FIGS. 2 and 3 show a flowchart showing a flow of a horizontal one-line process performed by the image processing apparatus 100.

Firstly, the system control unit 110 stores pixel data and each signal (VS signal, HS signal, DE signal) into the line buffer 120 on a pixel-by-pixel basis and supplies the DE signal to the edge detection unit 131.

The edge detection unit 131 detects an edge (rising edge or falling edge) of the supplied DE signal. When a rising edge is detected (S1: Yes), the edge detection unit 131 supplies a detection signal to the effective data start position hold unit 132 (S2). The effective data start position hold unit 132 holds the coordinate position of a pixel that is being processed when the detection signal is input and supplies that coordinate position (effective data start position) to each processing unit (S2).

When a falling edge is detected (S1: No, S3: Yes), the edge detection unit 131 supplies a detection signal to the effective data end position hold unit 133 (S4). The effective data end position hold unit 133 holds the coordinate position of a pixel that is being processed when the detection signal is input and supplies that coordinate position (effective data end position) to each processing unit (S4).

When a falling edge is detected, the comparison unit 140 determines whether or not the effective data section supplied from the effective data section measurement unit 134 conforms to the horizontal panel size, i.e., determines whether the effective data section is an image data transfer section or not (S5). When the effective data section conforms to the horizontal panel size (S5: Yes), the comparison unit 140 supplies a comparison result signal (match signal) to the image data extraction unit 151 and the output switching unit 152.

When the comparison result signal (match signal) is supplied (S5: Matching), the image data extraction unit 151 acquires the pixel data contained in the section between the effective data start position to the effective data end position from the line buffer 120 (S6). The image processing unit 160 performs processing such as image improving processing for the pixel data acquired by the image data extraction unit 151 and supplies the processed pixel data to the output switching unit 152 (S7).

When the comparison result signal (match signal) is input, the output switching unit 152 holds the section corresponding to that signal. That is, when the comparison result signal is input, the output switching unit 152 memorizes that the section between the positions supplied from the effective data start position hold unit 132 and the effective data end position hold unit 133 is an image data transfer section.

Note that when no edge is detected in the pixel to be processed (S1: No, and S3: No) or when the comparison result in the step S5 is non-matching (S5: No), the processes in the steps S6 and S7 are not performed.

When the process for one pixel has finished, the output switching unit 152 determines whether or not the process for one line has finished (S8). When the process for one line has not finished yet (S8: No), the processes in the steps S1 to S7 are performed for the next pixel.

When the process for one line has finished (S8: Yes), the output switching unit 152 determines whether or not there is a section that conforms to the horizontal panel size, i.e., whether or not there is an image data transfer section (S9). When there is no image data transfer section (S9: Non-matching), the output switching unit 152 reads out all the pixel data in the one line to be processed and each signal (VS signal, HS signal, DE signal) from the line buffer 120 and supplies them to the LCD panel unit 170 without performing any processing (S13).

When there is an image data transfer section (S9: Matching), the output switching unit 152 reads out the pixel data that are located before that image data transfer section and each signal (VS signal, HS signal, DE signal) from the line buffer 120 and supplies them to the LCD panel unit 170 without performing any processing (S10). Then, the output switching unit 152 acquires the pixel data corresponding to the image data transfer section from the image processing unit 160 and supplies the acquired pixel data to the LCD panel unit 170 (S11). In this process, the output switching unit 152 reads out the VS signal, the HS signal, and the DE signal of the image data transfer section from the line buffer 120 and supplies them to the LCD panel unit 170 without performing any processing. Then, the output switching unit 152 reads out pixel data and each signal (VS signal, HS signal, DE signal) from the position immediately behind the end position of the image data transfer section from the line buffer 120 and supplies them to the LCD panel unit 170 without performing any processing (S12).

The image processing apparatus 100 performs the process for one line in accordance with the above-described process flow. The image processing apparatus 100 repeats the above-described processes the same number of times as the number of lines contained in the frame data (number of vertical lines) and thereby processes the frame data.

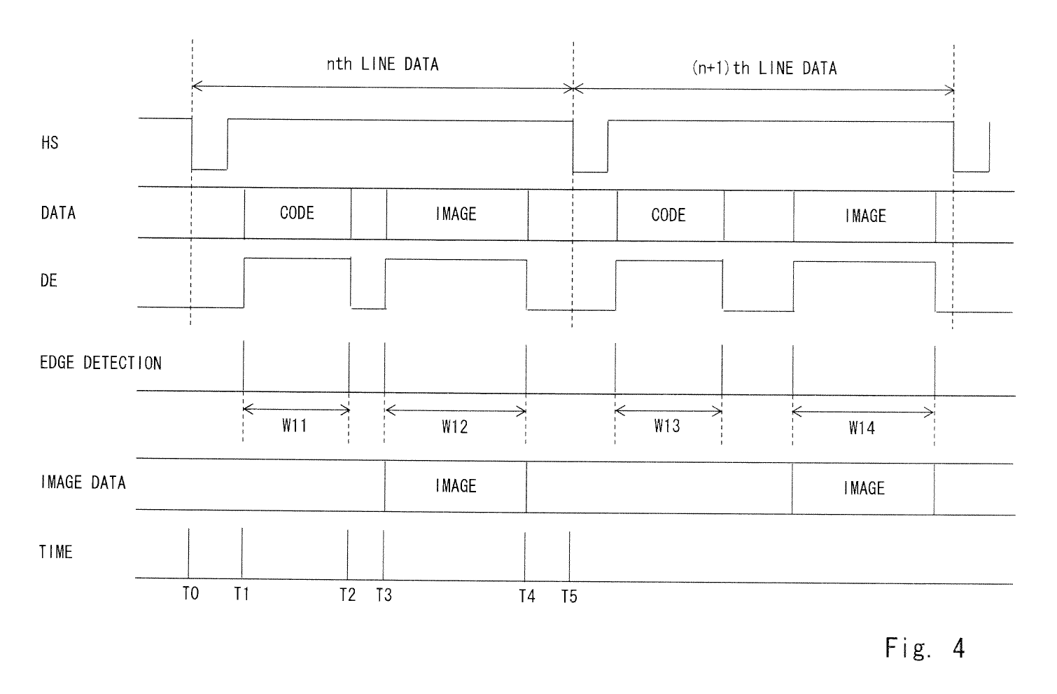

Next, processes performed by the image processing apparatus 100 according to this embodiment are explained with reference to a timing chart shown in FIG. 4. FIG. 4 is a timing chart showing relations between processes performed by the image processing apparatus 100 and signal states.

At a timing at which the HS signal falls, the first pixel data in the Nth line is input to the line buffer 120. That is, one line is processed in synchronization with the HS signal. At a timing T0 at which the HS signal falls, the first pixel data (pixel data at left corner) of the one line is stored into the line buffer 120.

At a timing T1 at which pixel data having an effective value is input, the DE signal rises. The edge detection unit 131 detects this rising edge and supplies the coordinate position of the pixel data that is being read at the timing T1 to the effective data start position hold unit 132. At the same time, this coordinate position is also supplied to the effective data section measurement unit 134 and the like. At a timing T2 at which the input of the pixel data having an effective value ends, the DE signal falls. The edge detection unit 131 detects this falling edge and supplies the coordinate position of the pixel data that is being read at the timing T2 to the effective data end position hold unit 133. At the same time, this coordinate position is also supplied to the effective data section measurement unit 134 and the like.

At the timing T2, the effective data section measurement unit 134 measures the section (number of pixels) between the coordinate position of the pixel corresponding to the timing T1 and the coordinate position of the pixel corresponding to the timing T2. Further, at the timing T2, the comparison unit 140 compares the section (number of pixels) measured by the effective data section measurement unit 134 with the horizontal panel size and thereby determines whether they match each other or not.

In this example, it is determined that the number of pixels contained in the section W11 between the timing T1 and T2 does not conform to the horizontal panel size. That is, the comparison unit 140 determines that no image data is transferred in the section W11. Therefore, the image processing is not performed for the pixel data contained in the section W11. At the timing T2, since the one-line process has not finished yet, the one-line process is continued.

Similarly, at a timing T3, the edge detection unit 131 detects the rising edge and supplies the coordinate position of the pixel data that is being read at the timing T3 to the effective data start position hold unit 132. At the same time, this coordinate position is also supplied to the effective data section measurement unit 134 and the like. At a timing T4, the DE signal falls. The edge detection unit 131 detects this falling edge and supplies the coordinate position of the pixel data that is being read at the timing T4 to the effective data end position hold unit 133. At the same time, this coordinate position is also supplied to the effective data section measurement unit 134 and the like.

At the timing T4, the effective data section measurement unit 134 measures the section (number of pixels) between the coordinate position of the pixel data corresponding to the timing T3 and the coordinate position of the pixel data corresponding to the timing T4. Further, at the timing T4, the comparison unit 140 compares the section (number of pixels) measured by the effective data section measurement unit 134 with the horizontal panel size and thereby determines whether they match each other or not.

In this example, the number of pixels contained in the section W12 between the timing T3 and T4 conforms to the horizontal panel size. That is, the comparison unit 140 determines that the section W12 is an image data transfer section. Therefore, the image processing is performed for the pixel data contained in the section W12. The image processing unit 160 performs a process for improving the image quality for these pixel data and then supplies the pixel data for which the image improving process was performed to the output switching unit 152. Further, since the comparison result signal (match signal) is input from the comparison unit 140 to the output switching unit 152, the output switching unit 152 memorizes the section W12 as an image data transfer section.

At a timing T5, the one-line process has finished. At the timing T5, the output switching unit 152 determines that image data was transferred in the section between the timing T3 and T4 based on the notification of the comparison result signal. The output switching unit 152 supplies, as the pixel data corresponding to the section between the timing T1 to T3, the pixel data read out from the line buffer 120 to the LCD panel unit 170 without performing any processing. The output switching unit 152 supplies, as the pixel data corresponding to the section between the timing T3 and T4, the pixel data supplied from the image processing unit 160 to the LCD panel unit 170. Further, the output switching unit 152 supplies, as the pixel data corresponding to the section between the timing T4 and T5, the pixel data read out from the line buffer 120 to the LCD panel unit 170 without performing any processing.

With the above-described processes, the image processing for the Nth line has finished, and then the image processing for the (N+1)th line is performed.

Next, advantageous effects of the image processing apparatus 100 according to this embodiment are explained. As described previously, the comparison unit 140 determines whether or not an effective data section is a section in which image data is transferred (i.e., image data transfer section) by comparing the effective data section with the horizontal panel size. That is, the comparison unit 140 can calculate an image data transfer section in a data transfer from the system control unit 110 to the LCD panel unit 170 without having any information about what kind of protocol is used for the data transfer. In other words, with the above-described configuration, the image processing apparatus 100 can correctly recognize image data without interpreting any information specifying the image data (e.g., effective data area information 410 shown in FIG. 19). Note that the image processing apparatus 100 can correctly recognize image data even when any information specifying the image data (e.g., effective data area information 410 shown in FIG. 19) is not inserted in the frame data. As a result, the pixel data acquisition unit 150 can appropriately acquire only desired pixel data.

Note that the image data transfer section is very long in comparison to other sections such as a section in which a noise is inserted and a section in which other code data is inserted. Therefore, the comparison unit 140 can correctly detect only sections in which an image is transferred by performing a comparison using the horizontal panel size.

By correctly detecting an image data transfer section, it is possible to correctly perform image processing such as image improving processing. Further, it is also possible to supply code data, which is effective data but is not image data, to a subsequent processing unit (such as the LCD panel unit 170 shown in FIG. 1) without performing any image processing for the code data. That is, it is possible to prevent the image processing from being incorrectly performed for code data, which is not image data.

Note that the above-described comparison unit 140 may perform the comparison with the horizontal panel size while allowing for some margin in consideration of noises. For example, in the case where the horizontal panel size is 1920 pixels, the comparison unit 140 may determine that an effective data section is an image data transfer section when the number of pixels contained in that effective data section is between 1917 and 1923. In this way, it is possible to cope with even such cases where pixels located on the front and rear borders of an image data transfer section are affected by noises.

Further, when a margin is defined as described above, the comparison unit 140 may notifies the amount of the difference between the image data transfer section and the horizontal panel size to the image processing unit 160. When the image processing unit 160 is notified that there is a difference equivalent to two pixels (e.g., while the horizontal panel size is 1920 pixels, the image data transfer section is 1922 pixels), for example, the image processing unit 160 may determine that a noise equivalent to two pixels exists in the image data transfer section and thereby perform such image processing that the noise is eliminated (or ignored). That is, the image processing unit 160 may adjust the image processing to be performed as appropriate according to the above-described difference in the number of pixels obtained in the comparison.

### Second Embodiment

There are cases in which image data and effective data other than image data (e.g., code data) are continuously located in the temporal direction, i.e., located adjacent to each other in the right-and-left direction within frame data. An image processing apparatus 100 according to this embodiment of the present invention is characterized in that it can appropriately process frame data having such an arrangement. In this embodiment, it is assumed two effective data are continuously located in the order of code data and image data. The image processing apparatus 100 according to this embodiment is explained hereinafter with particular emphasis on the differences from the image processing apparatus 100 according to the first embodiment.

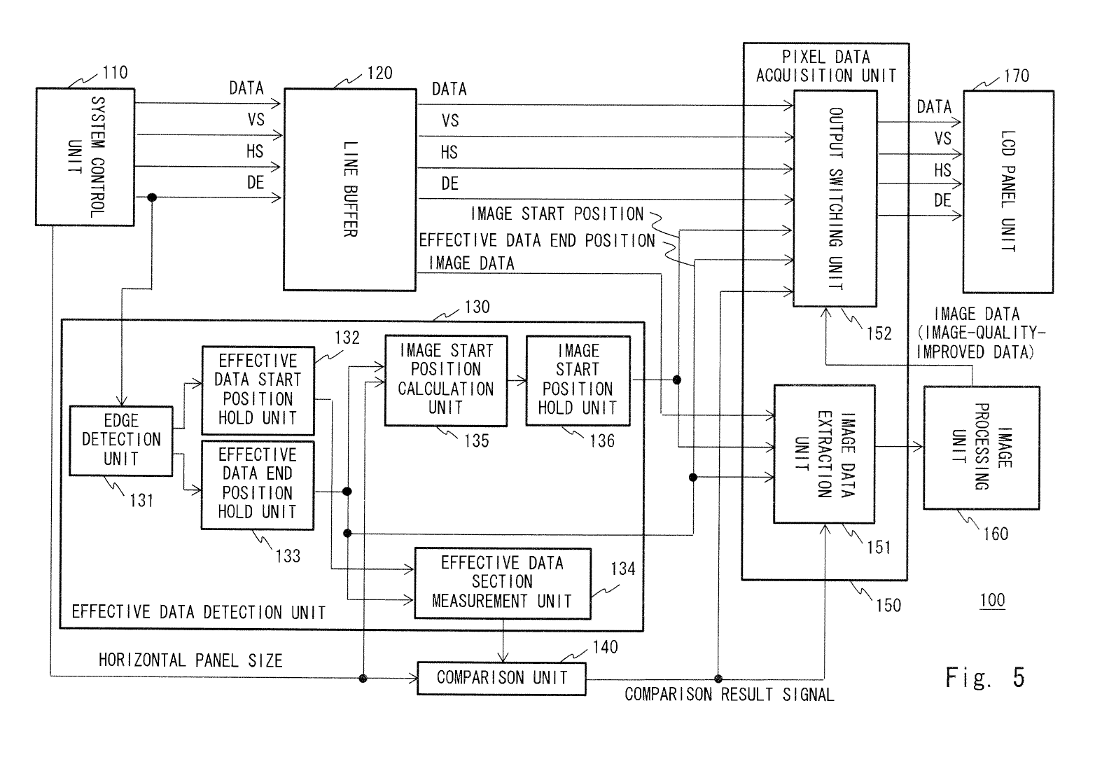

FIG. 5 is a block diagram showing a configuration of the image processing apparatus 100 according to this embodiment of the present invention. This image processing apparatus 100 includes, in addition to the configuration shown in FIG. 1, an image start position calculation unit 135 and an image start position hold unit 136, both of which are located inside the effective data detection unit 130. Further, the process performed by the comparison unit 140 is different from that in the first embodiment. Details of these differences are explained hereinafter in detail.

When a rising edge of the DE signal is detected, the effective data start position hold unit 132 supplies an effective data start position to the effective data section measurement unit 134.

When a falling edge of the DE signal is detected, the effective data end position hold unit 133 supplies an effective data end position to the effective data section measurement unit 134, the image start position calculation unit 135, the image data extraction unit 151, and the output switching unit 152.

The comparison unit 140 compares an effective data section supplied from the effective data section measurement unit 134 with the horizontal panel size. When the effective data section is larger than the horizontal panel size, the comparison unit 140 supplies a measured-size-large signal (signal having a value indicating that the effective data section is larger than the horizontal panel size) to the image data extraction unit 151 and the output switching unit 152 as a comparison result signal.

The horizontal panel size and the effective data end position are input to the image start position calculation unit 135. The image start position calculation unit 135 calculates the start position of the image data transfer section by using the following equation.

(Image start position)=(Effective data end position)−(Horizontal panel size)

The image start position calculation unit 135 supplies the calculated start position of the image data transfer section (hereinafter referred to as “image start position”) to the image start position hold unit 136.

The image start position hold unit 136 holds the supplied image start position and supplies the supplied image start position to the image data extraction unit 151 and the output switching unit 152.

The image start position, the effective data end position, and the comparison result signal are supplied to the image data extraction unit 151. When a measured-size-large signal is supplied, the image data extraction unit 151 recognizes the section between the image start position and the effective data end position as an image data transfer section. Then, the image data extraction unit 151 acquires the pixel data contained in the image data transfer section, i.e., the image data from the line buffer 120. The image data extraction unit 151 supplies the acquired image data to the image processing unit 160.

The image start position, the effective data end position, and the comparison result signal are supplied to the output switching unit 152. When a measured-size-large signal is supplied, the output switching unit 152 holds the image start position and the effective data end position that were input simultaneously with the measured-size-large signal. In this way, the output switching unit 152 memorizes the section between the image start position and the effective data end position as an image data transfer section.

The other processing of the above-described processing unit and processing of the processing unit that is not mentioned in the above explanation are similar to those of the first embodiment.

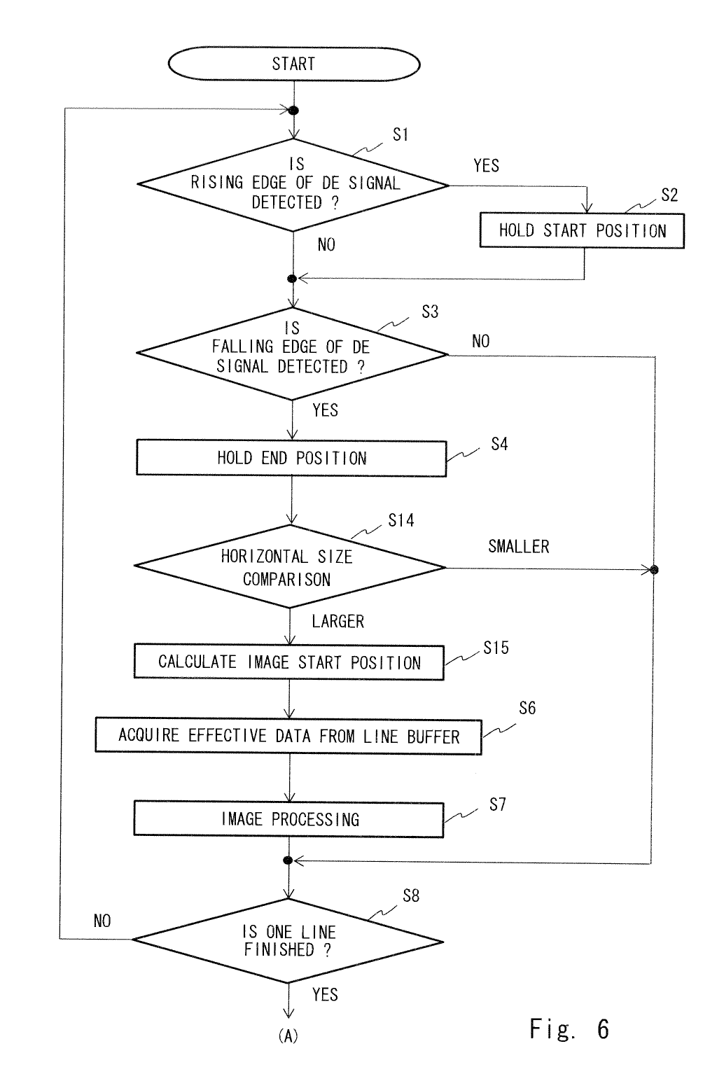

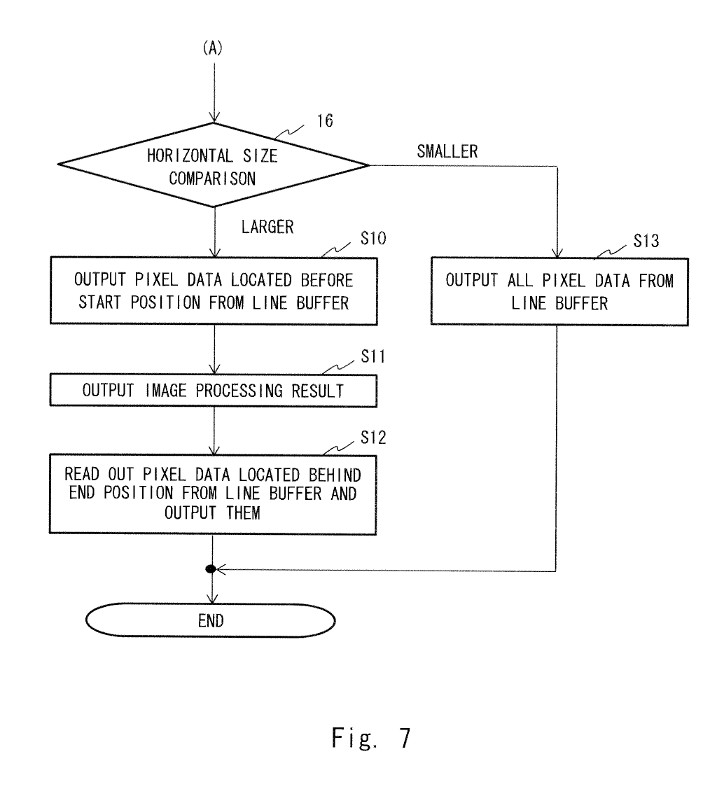

Next, a flow of a horizontal one-line process performed by the image processing apparatus 100 according to this embodiment is explained with reference to FIGS. 6 and 7. Only the processes that are different from those shown in FIGS. 2 and 3 are explained hereinafter.

The comparison unit 140 determines whether or not an input effective data section is larger than the horizontal panel size (S14 and S16), instead of performing processes in the step S5 in FIG. 2 and the step S9 in FIG. 3.

When the DE signal falls, the comparison unit 140 compares the input effective data section with the horizontal panel size. Then, when the effective data section is larger than the horizontal panel size, the comparison unit 140 determines that the effective data section is an image data transfer section (S14: Larger).

When the effective data section is larger than the horizontal panel size (S14: Larger), the image start position calculation unit 135 calculates the start position of the image data transfer section by using the above-shown equation (S15). Note that in the above explanation made with reference to FIG. 5, the image start position calculation unit 135 calculates an image start position at all times regardless of the comparison result between the effective data section and the horizontal panel size. However, as shown in the above example, the image start position calculation unit 135 may calculate an image start position in response to the comparison result of the comparison unit 140. After that, image data is extracted (S6) and image processing is performed for the extracted image data (S7).

After the process for one line has finished (S8: Yes), the output switching unit 152 determines whether or not there is an effective data section larger than the horizontal panel size, i.e., whether or not there is an image data transfer section (S16). The subsequent processes are similar to those shown in FIG. 3.

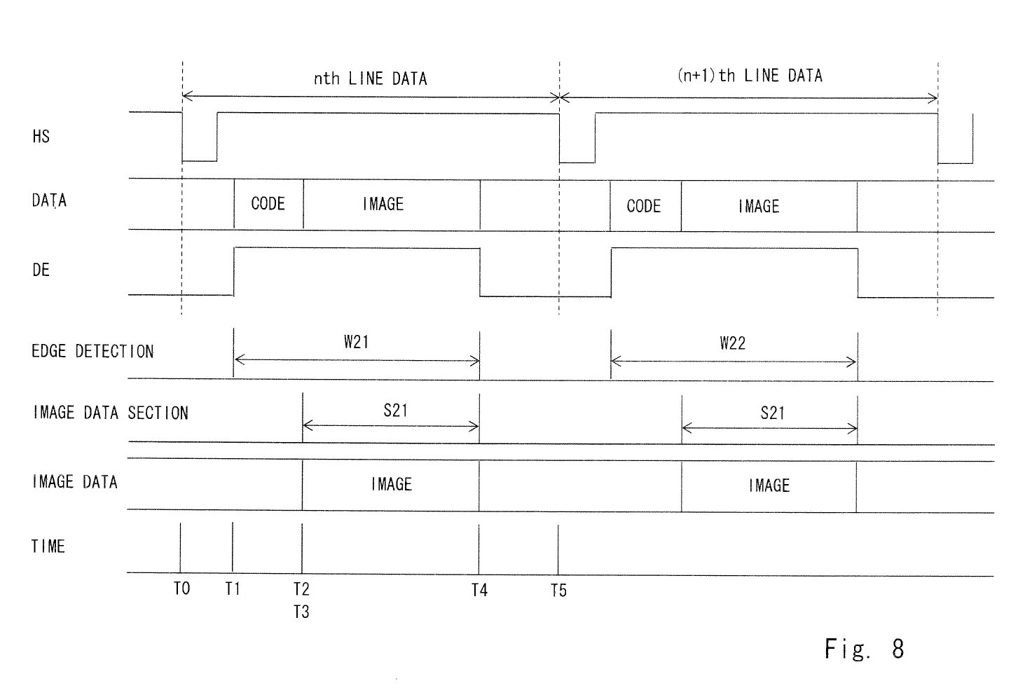

Next, processes performed by the image processing apparatus 100 according to this embodiment are explained with reference to a timing chart shown in FIG. 8. The main points of this timing chart are explained hereinafter.

As shown in the figure, code data and image data are continuously arranged within frame data. Therefore, a timing T2 at which the input of the code data has finished is simultaneous with a timing T3 at which the input of the image data starts. Therefore, the effective data section W21 measured by the effective data section measurement unit 134 becomes larger than the horizontal panel size.

When the effective data section is larger than the horizontal panel size, the image start position calculation unit 135 calculates the start position of the image data by subtracting the horizontal panel size from the end position of the effective data. In this manner, an image data transfer section S21 is calculated.

Next, advantageous effects of the image processing apparatus 100 according to this embodiment are explained. As described above, image data can be located just behind code data, which is effective data, in frame data. However, the image start position calculation unit 135 of the effective data detection unit 130 according to this embodiment can correctly calculate the start position of image data even when the image data is located just behind code data. As a result, it is possible to appropriately acquire effective data including image data.

### Third Embodiment

An image processing apparatus according to this embodiment of the present invention is characterized in that it can appropriately handle frame data in which two effective data are continuously located in the order of image data and code data. An image processing apparatus 100 according to this embodiment is explained hereinafter with particular emphasis on the differences from those of the first and second embodiments.

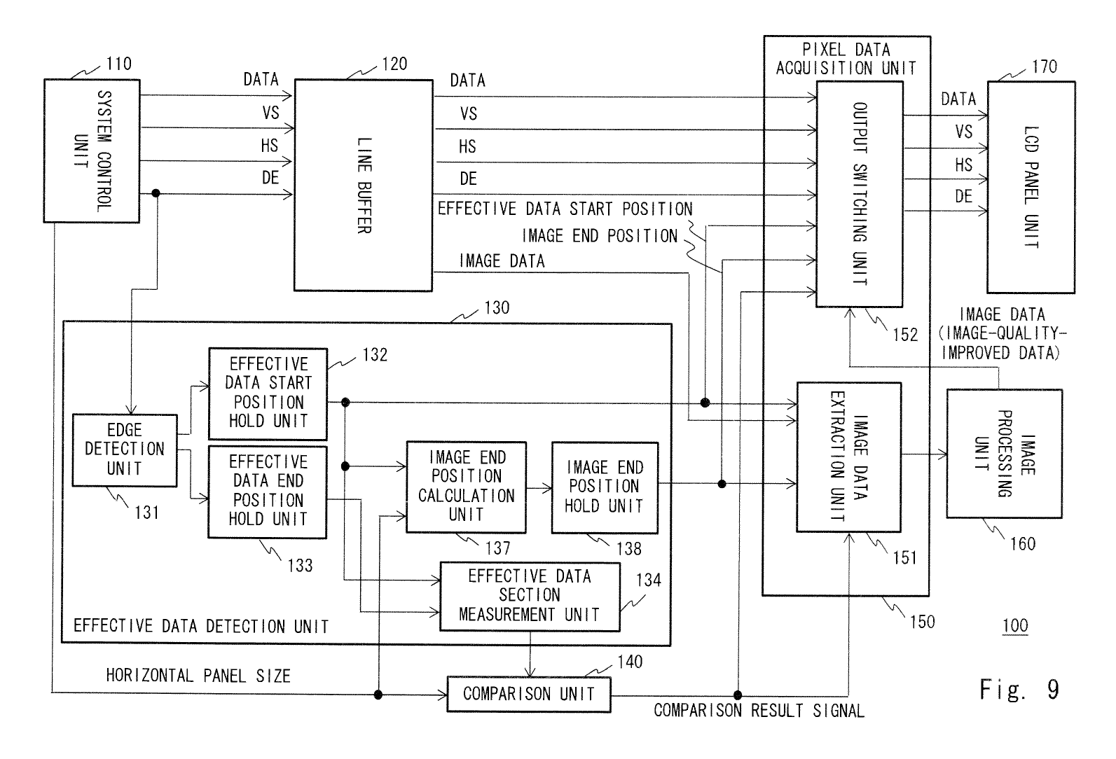

FIG. 9 is a block diagram showing a configuration of an image processing apparatus 100 according to this embodiment of the present invention. This image processing apparatus 100 includes, in addition to the configuration shown in FIG. 1, an image end position calculation unit 137 and an image end position hold unit 138, both of which are located inside the effective data detection unit 130.

When a rising edge of the DE signal is detected, the effective data start position hold unit 132 supplies an effective data start position to the effective data section measurement unit 134, the image end position calculation unit 137, the image data extraction unit 151, and the output switching unit 152.

When a falling edge of the DE signal is detected, the effective data end position hold unit 133 supplies an effective data end position to the effective data section measurement unit 134.

The horizontal panel size and the effective data start position are supplied to the image end position calculation unit 137. The image end position calculation unit 137 calculates the end position of the image data transfer section by using the following equation.

(Image end position)=(Effective data start position)+(Horizontal panel size)

The image end position calculation unit 137 supplies the calculated end position of the image data transfer section (hereinafter referred to as “image end position”) to the image end position hold unit 138.

The image end position hold unit 138 holds the supplied image end position and supplies the supplied image end position to the image data extraction unit 151 and the output switching unit 152.

The other processing of the above-described processing unit and processing of the processing unit that is not mentioned in the above explanation are similar to those of the second embodiment.

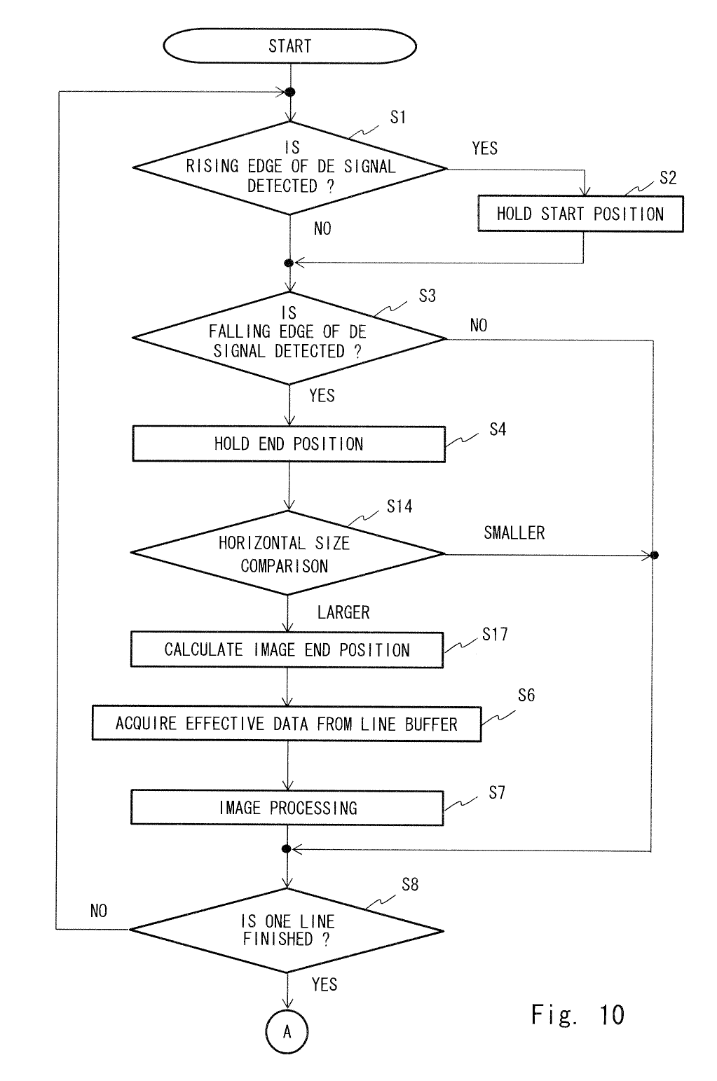

Next, a flow of a horizontal one-line process performed by the image processing apparatus 100 according to this embodiment is explained with reference to FIG. 10. FIG. 10 shows a flowchart showing a flow of a horizontal one-line process performed by the image processing apparatus 100 according to this embodiment. Note that in FIG. 10, the flow of the processes performed after the symbol (A) in the figure is omitted. That is, since the processes performed after the symbol (A) are completely the same as those shown in FIG. 7, their illustration as well as their explanation are omitted. Further, only the processes that are different from those shown in FIG. 6 are explained hereinafter.

When the DE signal falls, the comparison unit 140 compares an input effective data section with the horizontal panel size. When the effective data section is larger than the horizontal panel size (S13: Larger), the image end position calculation unit 137 calculates the image end position by using the effective data start position and the horizontal panel size (S17). The processes performed after the step S17 are roughly the same as those shown in FIG. 6, and therefore their explanation is omitted.

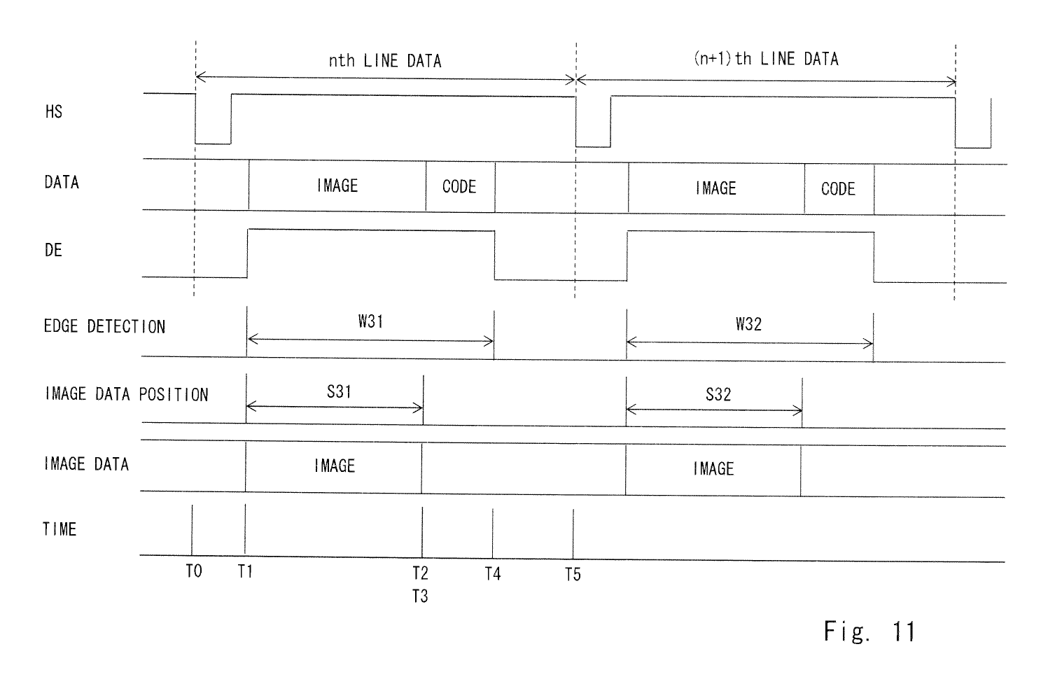

Next, processes performed by the image processing apparatus 100 according to this embodiment are explained with reference to a timing chart shown in FIG. 11. The main points of this timing chart are explained hereinafter.

As shown in the figure, image data and code data are continuously arranged in the frame data. Therefore, a timing T2 at which the input of the image data has finished is simultaneous with a timing T3 at which the input of the code data starts. Therefore, the effective data section W31 measured by the effective data section measurement unit 134 becomes larger than the horizontal panel size.

The image end position calculation unit 137 can calculate the image end position by adding the horizontal panel size to the effective data start position. In this manner, an image data transfer section S31 is calculated.

Next, advantageous effects of the image processing apparatus 100 according to this embodiment are explained. The image end position calculation unit 137 determines the image start position by using the effective data start position and the horizontal panel size. In this way, the image processing apparatus 100 can correctly calculate the image data transfer section even when two effective data are continuously arranged in the order of image data and code data in the frame data. As a result, it is possible to appropriately handle effective data including image data.

### Fourth Embodiment

An image processing apparatus 100 according to this embodiment of the present invention is characterized in that it can appropriately handle frame data in which three effective data are continuously located in the order of code data, image data, and another code data. An image processing apparatus 100 according to this embodiment is explained hereinafter with particular emphasis on the differences from those of the first to third embodiments.

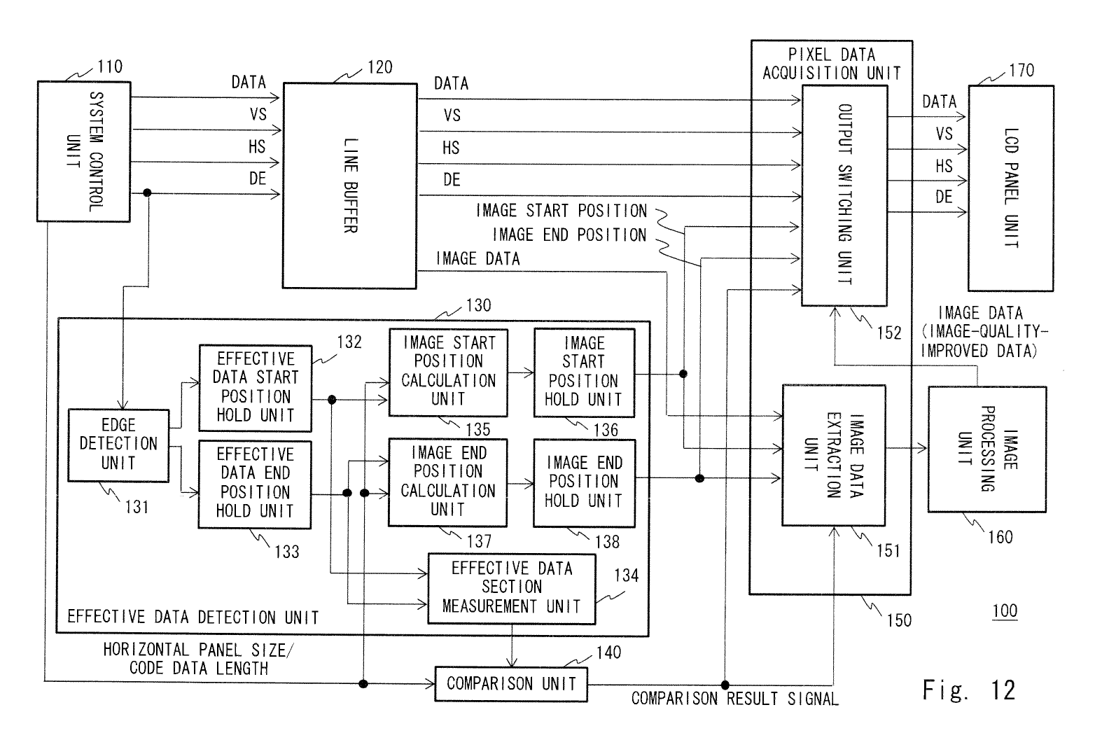

FIG. 12 is a block diagram showing a configuration of an image processing apparatus according to this embodiment of the present invention. This image processing apparatus 100 includes an image start position calculation unit 135, an image start position hold unit 136, an image end position calculation unit 137 and an image end position hold unit 138, all of which are located inside the effective data detection unit 130.

When a rising edge of the DE signal is detected, the effective data start position hold unit 132 supplies an effective data start position to the effective data section measurement unit 134 and the image start position calculation unit 135.

When a falling edge of the DE signal is detected, the effective data end position hold unit 133 supplies an effective data end position to the effective data section measurement unit 134 and the image end position calculation unit 137.

The system control unit 110 supplies the data length of code data (code data length) contained in the frame data as well as the horizontal panel size to the image start position calculation unit 135, the image end position calculation unit 137, and the comparison unit 140. The system control unit 110 may memorize the data length of the code data inserted into the frame data when the frame data is generated, for example, and supply this data length to the above-mentioned processing units. In this embodiment, three effective data are continuously arranged in the order of code data, image data, and another code data. In the following explanation, it is assumed that the system control unit 110 notifies the data length of the code data located in front of the image data and the data length of the code data located behind the image data to the above-mentioned processing units.

The horizontal panel size, the code data length, and the effective data start position are supplied to the image start position calculation unit 135. The image start position calculation unit 135 calculates the image start position by using the following equation.

(Image start position)=(Effective data start position)+(Data length of code data (located in front of image data))

The horizontal panel size, the code data length, and the effective data end position are supplied to the image end position calculation unit 137. The image end position calculation unit 137 calculates the image end position by using the following equation.

(Image end position)=(Effective data end position)−(Data length of code data (located behind image data))

The other processing of the above-described processing unit and processing of the processing unit that is not mentioned in the above explanation are similar to those of the second embodiment. Note that the process flow of the image processing apparatus 100 according to this embodiment is the same as the process flow shown in FIGS. 6 and 7 except that the above-described calculations of the start/end positions of an image data transfer section are performed in parallel in this embodiment. Therefore, the explanation using a flowchart is omitted.

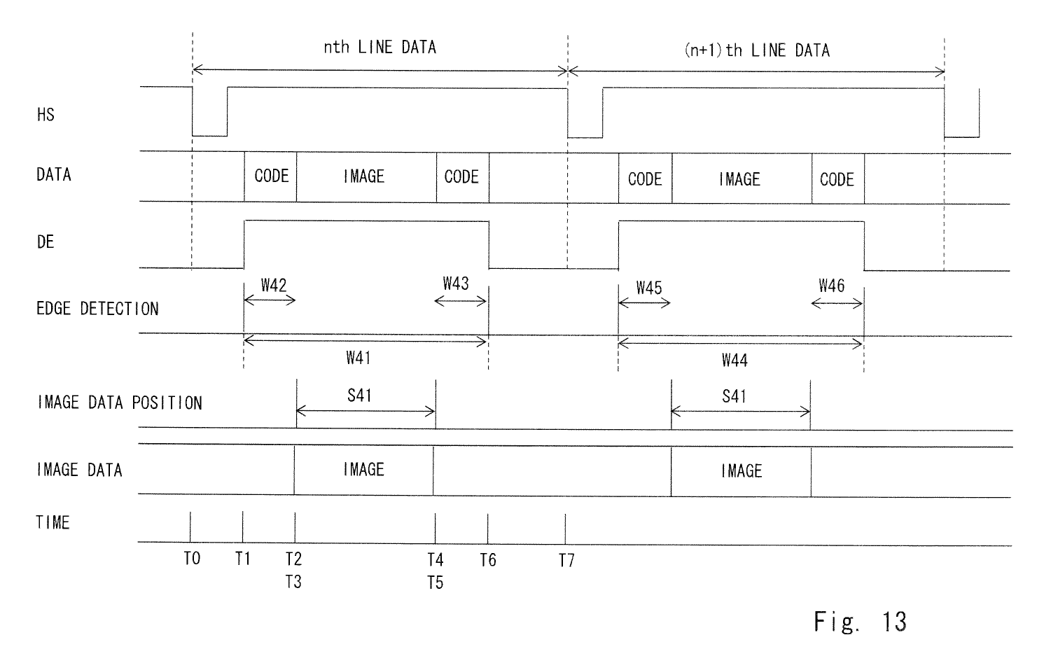

Next, processes performed by the image processing apparatus 100 according to this embodiment are explained with reference to a timing chart shown in FIG. 13. The main points of this timing chart are explained hereinafter.

As shown in the figure, three effective data are continuously arranged in the order of code data, image data, and another code data in the frame data. Therefore, a timing T2 at which the input of the code data has finished is simultaneous with a timing T3 at which the input of the image data starts. Further, a timing T4 at which the input of the image data has finished is simultaneous with a timing T5 at which the input of another code data starts. Therefore, the effective data section W41 measured by the effective data section measurement unit 134 becomes larger than the horizontal panel size.

When the effective data section is larger than the horizontal panel size, the image start position calculation unit 135 calculates the image start position by using the code length W42. Similarly, the image end position calculation unit 137 calculates the image end position by using the code length W43. In this manner, an image data transfer section S41 is calculated.

Next, advantageous effects of the image processing apparatus 100 according to this embodiment are explained. As described above, the image start position calculation unit 135 and the image end position calculation unit 137 can calculate the image start position and the image end position respectively by using the horizontal panel size and the data length of the code data. In this way, the image processing apparatus 100 can correctly calculate the image data transfer section even when three effective data are continuously arranged in the order of code data, image data, and another code data in the frame data. As a result, it is possible to appropriately handle effective data including image data.

Note that although an example in which the system control unit 110 notifies the code lengths of code data located in front of and behind image data is explained in the above explanation, the present invention is not limited to this configuration. That is, the system control unit 110 may notify at least one of the code data. An example in which the system control unit 110 notifies only the data length of the code data located in front of the image data is explained hereinafter.

The image start position calculation unit 135 calculates the image start position by using the following equation.

(Image start position)=(Effective data start position)+(Data length of code data (located in front of image data))

The image start position calculation unit 135 notifies the calculated image start position to the image end position calculation unit 137. The image end position calculation unit 137 calculates the image end position by using the following equation.

(Image end position)=(Image start position)+(Horizontal panel size)

As described above, the image processing apparatus 100 can calculate the image data transfer section even when the system control unit 110 notifies the data length of only one code data that is located in front of or behind the image data.

### Other Embodiments

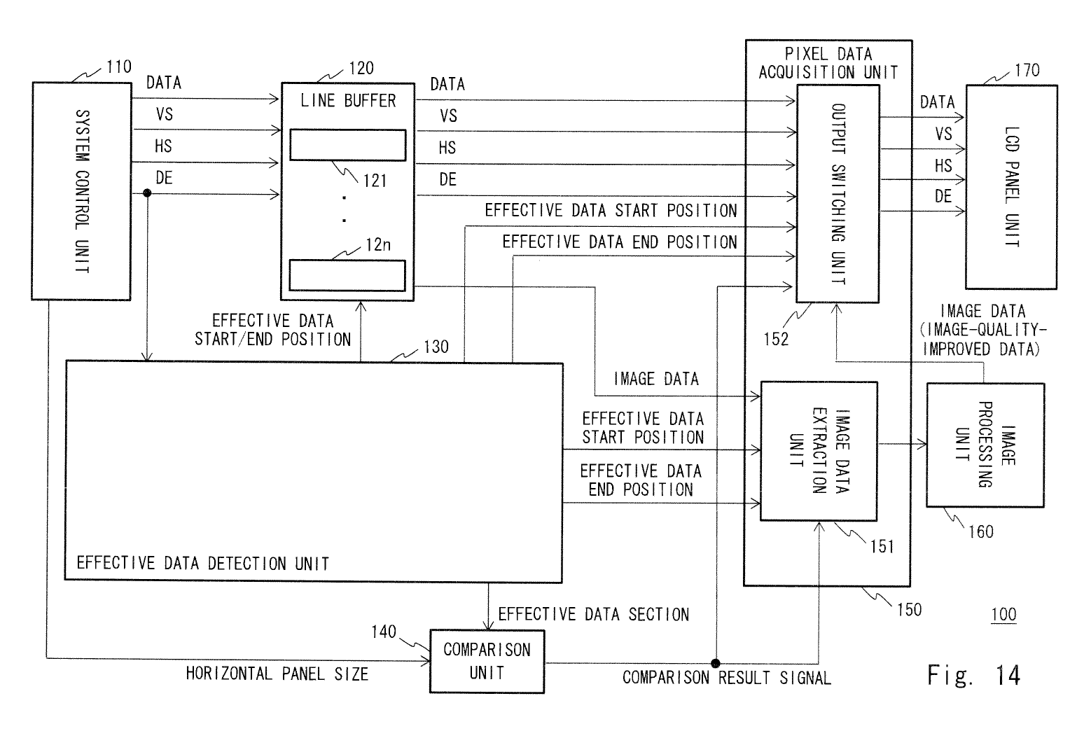

As another embodiment of the present invention, an image processing apparatus 100 can adopt a configuration shown in FIG. 14. The outline of the configuration shown in FIG. 14 is explained hereinafter. The line buffer 120 includes a plurality of storage areas in addition to the storage area in which the VS signal, the HS signal, and the DE signal are stored. In these plurality of storage areas, pixel data of sections, for each of which the DE signal is effective (1), are stored.

The effective data detection unit 130 detects periods each having an effective value (1) as effective data sections by referring to the value of the DE signal (i.e., referring to whether the value of the DE signal is 0 or 1) instead of referring to the edge of the DE signal. Whenever the effective data detection unit 130 detects an effective data section, the effective data detection unit 130 changes the storage area of the pixel data within the line buffer 120, notifies the effective data section to the comparison unit 140, and notifies the effective data start position and the effective data end position to the pixel data acquisition unit 150 (image data extraction unit 151 and output switching unit 152).

The comparison unit 140 specifies the image data transfer section by comparing each effective data section with the horizontal panel size. The comparison unit 140 notifies the specified image data transfer section as a comparison result signal.

Each processing unit located in the pixel data acquisition unit 150 acquires pixel data from the line buffer 120 based on the comparison result obtained by the comparison unit 140, i.e., based on the image data transfer section.

In the above-described configuration, the edge of the DE signal is not detected, and it is possible to implement the processing of each processing unit (effective data detection unit 130, comparison unit 140, pixel data acquisition unit 150, image processing unit 160) by a program running on an arbitrary computer. The program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

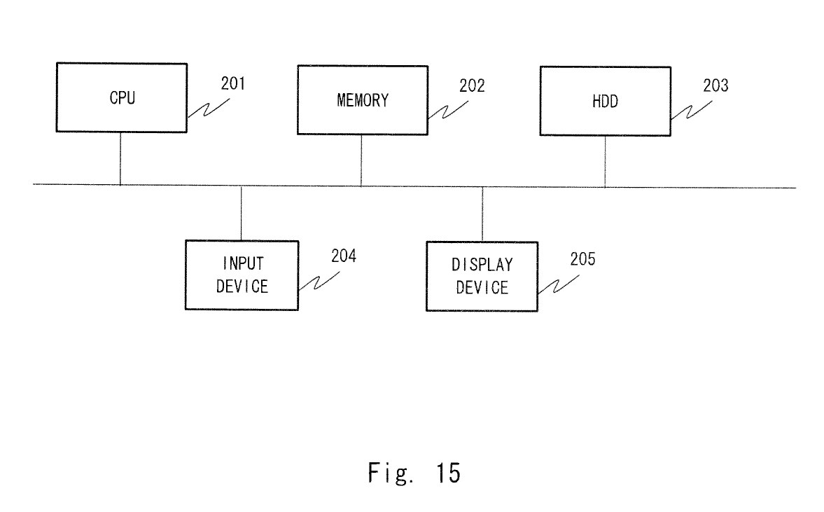

FIG. 15 shows an example of a hardware configuration of a system in which each processing unit of an image processing apparatus 100 is implemented by a program. For example, this hardware configuration includes a central processing unit (CPU) 201 and a memory 202. The CPU 201 and the memory 202 are connected to a hard disk drive (HDD) 203, which serves as an auxiliary storage device, through a bus. Typically, this system also includes user-interface-hardware. Examples of the user-interface-hardware include an input device 204 for assisting an input operation, such as a pointing device (a mouse, a joystick, and the like) and a keyboard, and a display device 205 for presenting visual data to a user, such as a liquid crystal display device. The storage medium such as the hard disk drive 203 can store therein a computer program that cooperates with the operating system and thereby provides commands and the like to the CPU 201 and the like in order to implement the function of each component of the image processing apparatus 100. That is, a program is unfolded on the memory 202 and the CPU 201 performs processing according to the program and cooperates with other hardware configurations so that each processing unit of the image processing apparatus 100 is configured. Further, each process of the image processing apparatus 100 is implemented by execution of a certain program by the CPU 201.

Note that the present invention is not limited to the above-described embodiments and various modifications can be made to the embodiments without departing from the spirit and scope of the present invention. For example, although the image processing unit 160 extracts image data and performs a process for improving the image quality for that image data in the above-described embodiments, the present invention is not limited to this configuration. That is, the image processing unit 160 may perform other arbitrary processes.

The image processing apparatus 100 may be any apparatus that extracts image data from frame data, and examples thereof include a television set, a display device, an industrial optical microscope, a digital still camera, a digital photo frame, a mobile phone (including those having a PDA function), and a projector. Further, the display unit (LCD panel unit 170) does not necessarily have to be integrally formed within the image processing apparatus 100. That is, the image processing apparatus 100 may include each processing unit (line buffer 120, effective data detection unit 130, comparison unit 140, pixel data acquisition unit 150) and may be constructed in such a manner that the image processing apparatus is separated in terms of the hardware from the display unit. That is, the image processing apparatus 100 may include only the processing units (line buffer 120, effective data detection unit 130, comparison unit 140, pixel data acquisition unit 150, and, if necessary, image processing unit 160) and may be constructed as a chip (semiconductor integrated circuit) such as an image improving chip that can be embedded into an apparatus having a display unit.

Further, although the above-described embodiments are explained on the assumption that image data is extracted from frame data, the present invention is not limited to this configuration. For example, code data (data that is effective data but is not image data) may be acquired and a process using the code data may be performed. That is, a code data extraction unit may be provided in place of the image data extraction unit 151. In such cases, this extraction unit may acquire effective data from the line buffer 120 when the comparison result signal of the comparison unit 140 indicates non-matching.

The above-described first to fourth embodiments handle the following frame data formats:
(1) A case where image data and code data are not continuously arranged (First embodiment);
(2) A case where two effective data are continuously arranged in the order of code data and image data (Second embodiment);
(3) A case where two effective data are continuously arranged in the order of image data and code data (Third embodiment); and
(4) A case where three effective data are continuously arranged in the order of code data, image data, and another code data (Fourth embodiment).

In general, when the configuration of the system control unit 110 and the configuration of the LCD panel unit 170 are determined, the frame data format is also uniquely determined. However, even if the above-described formats (1) to (4) are randomly input, it is still possible to handle these formats by extending the present invention. For example, the system control unit 110 successively notifies the type of format in which data is output, to the comparison unit 140 and the effective data detection unit 130. Further, if necessary, the system control unit 110 also supplies the size of code data to the comparison unit 140. The comparison unit 140 changes the comparison method (determines whether or not the effective data section conforms to the horizontal panel size, or determines whether or not the effective data section is larger than the horizontal panel size) in response to the notification of the data format. The position calculation unit(s) (image start position calculation unit 135 and/or image end position calculation unit 137) located within the effective data detection unit 130 may calculate the border point(s) of the image data (image start position and/or image end position) according to the notified data format by using the above-mentioned technique.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first to fourth embodiments can be combined as desirable by one of ordinary skill in the art.

What is claimed is:

1. An image processing apparatus that processes frame data in a raster scan form, the frame data being input in synchronization with a data enable signal indicating effectiveness/ineffectiveness of each pixel data, the image processing apparatus comprising:
a buffer unit that successively holds pixel data contained in the frame data;
an effective data detection unit that detects an effective data section of the frame data based on the data enable signal;
a comparison unit that compares the effective data section detected by the effective data detection unit with a pre-specified display size; and
a pixel data acquisition unit that acquires pixel data from the buffer unit based on a comparison result obtained by the comparison unit.

2. The image processing apparatus according to claim 1, wherein the effective data detection unit detects that the effective data section starts when a rising edge of the data enable signal is detected, and detects that the effective data section has finished when a falling edge of the data enable signal is detected.

3. The image processing apparatus according to claim 1, wherein the comparison unit compares the effective data section with the display size, and when they match each other, determines that the effective data section is an image data transfer section, the image data transfer section being a section in which an image is transferred.

4. The image processing apparatus according to claim 1, wherein the comparison unit determines that the effective data section includes an image data transfer section when the effective data section is larger than the display size, the image data transfer section being a section in which an image is transferred.

5. The image processing apparatus according to claim 4, further comprising a position calculation unit that calculates a start position or an end position of the image data transfer section based on the effective data section and the display size.

6. The image processing apparatus according to claim 5, wherein the position calculation unit calculates the start position or the end position of the image data transfer section based on a data length of effective data other than image data in addition to the effective data section and the display size.

7. The image processing apparatus according to claim 5, wherein the position calculation unit calculates the start position of the image data transfer section by subtracting the display size from the end position of the effective data section.

8. The image processing apparatus according to claim 5, wherein the position calculation unit calculates the end position of the image data transfer section by adding the display size to the start position of the effective data section.

9. The image processing apparatus according to claim 3, further comprising an image processing unit that performs image processing for pixel data relating to an image, wherein
the pixel data acquisition unit comprises:
an image data acquisition unit that acquires pixel data of the image data transfer section from the buffer unit and supplies the acquired pixel data to the image processing unit; and
an output switching unit that outputs, in the image data transfer section, pixel data which is output from the image processing unit and for which image processing is already performed, and outputs, in a section other than the image data transfer section, pixel data which is readout from the buffer unit without performing any processing.

10. The image processing apparatus according to claim 1, further comprising a display unit that generates display image information by using pixel data acquired by the pixel data acquisition unit.

11. The image processing apparatus according to claim 1, wherein the comparison unit determines that the effective data section and the display size match each other when their difference is equal to or smaller than a predetermined value in a comparison of the effective data section and the display size.

12. The image processing apparatus according to claim 9, wherein
when the effective data section and the display size do not completely match with each other in their comparison and their difference is equal to or smaller than a predetermined value, the comparison unit determines that the effective data section and the display size match each other and notifies the difference to the image processing unit, and
the image processing unit performs the image processing based on the difference.

13. An image processing method for processing frame data in a raster scan form, the frame data being input in synchronization with a data enable signal indicating effectiveness/ineffectiveness of each pixel data, the image processing method comprising:
detecting an effective data section of the frame data based on the data enable signal;
comparing the detected effective data section with a pre-specified display size; and
acquiring pixel data contained in the frame data based on a comparison result.

14. A non-transitory computer readable medium storing an image processing program that causes a computer to execute an image processing method according to claim 13.
